(19) United States
(12) Patent Application Publication
(10) Pub. No.: US 2025/0060263 A1
(43) Pub. Date: Feb. 20, 2025

(54) MEASURING METHOD FOR DETECTING A MECHANICAL FORCE ACTING ON AN OBJECT USING A FIBER OPTIC SENSOR UNIT

(71) Applicant: Hitachi Rail GTS Deutschland GmbH, Ditzingen (DE)

(72) Inventors: Thomas Grob, Leonberg (DE); Kai Schicker, Rosenbach (DE); Rainer Klemm, Steinheim (DE)

(73) Assignee: Hitachi Rail GTS Deutschland GmbH, Ditzingen (DE)

(21) Appl. No.: 18/935,460

(22) Filed: Nov. 2, 2024

Related U.S. Application Data
(63) Continuation of application No. PCT/EP2023/061622, filed on May 3, 2023.

(30) Foreign Application Priority Data
May 4, 2022 (DE) 10 2022 204 419.3

(51) Int. Cl. G01L 1/24; B61L 1/16

(52) U.S. Cl. CPC G01L 1/246; B61L 1/166

(57) ABSTRACT

A measuring method for detecting a mechanical force acting on an object using a fiber optic sensor unit is disclosed. At least one measuring channel has a sensor fiber with a fiber Bragg grating embedded in the sensor fiber with a Bragg wavelength and a sensor detection element. The sensor fiber is fixed to the object in the area of the sensor FBG. The method includes coupling light from a light source into the sensor fiber and detecting the light reflected and/or transmitted by the sensor FBG by the sensor detection element. The light source has a wavelength-dependent intensity distribution with an edge. A wavelength change in the Bragg wavelength of the sensor FBG is determined by evaluating a measurement signal which has an intensity change in the detected light intensity of the entire light reflected by the sensor FBG and/or of the entire light transmitted by the sensor FBG.

### CROSS-REFERENCE TO RELATED APPLICATIONS

This continuation application claims priority to PCT/EP2023/061622 filed on May 3, 2023, which has published as WO 2023/213851 A1 and also the German application number DE 10 2022 204 419.3 filed on May 4, 2022, the entire contents of which are fully incorporated herein with these references.

### DESCRIPTION

### Field of the Invention

The invention relates to a measuring method for detecting a mechanical force acting on an object by means of a fiber optic sensor unit, wherein the fiber optic sensor unit has at least one measuring channel which comprises a sensor fiber with at least one sensor fiber Bragg grating (sensor FBG) embedded in the sensor fiber with a Bragg wavelength, and a sensor detection element, wherein the sensor fiber is attached to the object in the area of the sensor FBG. The invention also relates to a measuring device with a fiber optic sensor unit.

### Background of the Invention

A measuring method for detecting a mechanical force acting on an object by means of a fiber optic sensor unit is known, for example, from DE 10 2017 119 810 B4.

Fiber optic sensors are used to detect mechanical variables in many technical areas, e.g. to investigate loads on components and mechanical stresses in structures. In the railroad sector, fiber optic sensors are used in particular for axle counting.

A fiber optic sensor comprises a sensor fiber (optical fiber) in which a fiber Bragg grating (FBG) is embedded. Each fiber Bragg grating has a reflection spectrum (spectrum within which the fiber Bragg grating reflects light) with a reflection peak at the Bragg wavelength. By coupling light into the sensor fiber, light is supplied to the fiber Bragg grating, wherein wavelengths that lie within the reflection spectrum of the fiber Bragg grating are reflected by the fiber Bragg grating. The Bragg wavelength is generally defined as λB=neff·2λ=neff·λ, where neff is the effective refractive index and λ is the grating period of the fiber Bragg grating. When a load is applied to the fiber Bragg grating, the sensor fiber and thus the fiber Bragg grating is stretched or compressed and the reflection or transmission wavelength of the fiber Bragg grating changes so that, depending on the stretching/compression of the fiber Bragg grating, light of different wavelengths is reflected and can be fed to an evaluation and analysis unit.

From DE 10 2014 100 653 B4, it is known to split the light beam emerging from the sensor fiber into 2 partial beams for evaluating the light, wherein one of the partial beams passes through an edge filter before it hits a photoelectric element, e.g. a photodiode, and the other partial beam is directed unfiltered to another photoelectric element. The output signals of the photoelectric elements are set in relation to each other in order to determine the reflected wavelength. The light emerging from the sensor fiber is split by means of a beam splitter. In the devices known from EP 3 069 952 A1 and DE 10 2012 104 874 B4, the beam splitter and the required filter are mounted with the photoelectric elements on a plate and form an optoelectronic chip (OEC).

DE 10 2017 119 810 B4 discloses a simplified OEC in which the beam splitting into the 1st (filtered) beam component and the 2nd (unfiltered) beam component is not performed by a beam splitter, but by reflection of the light emerging from the optical fiber at the surface of the filter by reflection directly at the filter. A filtered transmission intensity and an unfiltered reflection intensity are therefore measured. By dividing the transmission intensity by the reflection intensity, an intensity quotient is obtained from which the wavelength of the fiber Bragg grating in the optical fiber can be deduced.

The known solutions are based on beam splitting and edge filtering of a partial beam, e.g. using a Fabry-Pérot interferometer. Although this enables precise absolute measurement of the reflected wavelength, OECs are required which have a relatively complex structure and are therefore too expensive to offer an attractive and competitive product, particularly for applications in the railroad sector.

### SUMMARY OF THE INVENTION

### Object of the Invention

It is therefore the object of the invention to propose a simplified method and an optical measuring device which has a simpler construction than previously known and is particularly suitable for use in axle counting methods.

### DESCRIPTION OF THE INVENTION

According to the invention, this object is solved by a method according to the first independent claim and a measuring device according to next independent claim.

In the method according to the invention, the detection of the light reflected and/or transmitted by the sensor FBG is carried out by means of the sensor detection element over the entire wavelength range of the light reflected and/or transmitted by the sensor FBG. The method according to the invention comprises determining a wavelength change in the Bragg wavelength of the sensor FBG by evaluating a measurement signal which comprises an intensity change in the light intensity detected by the sensor detection element (10). The light intensity of the light reflected by the sensor FBG and/or transmitted by the sensor FBG is thus evaluated over the entire wavelength range. In other words, the light reflected and/or transmitted by the sensor FBG is detected and evaluated unfiltered.

The invention takes advantage of the fact that precise wavelength measurement is not required for certain applications (e.g. axle counting in the railroad sector). Rather, it is sufficient to know whether a change in the Bragg wavelengths of the sensor FBG has taken place.

In the method according to the invention, therefore, the exact Bragg wavelength of the sensor FBG is not measured, but only a change in wavelength. For this purpose, the reflected or transmitted light intensity is detected by the sensor detection element over the entire wavelength range (i.e. unfiltered in relation to wavelength). The sensor detection element therefore detects in the entire wavelength range of the light coupled into the sensor fiber. According to the invention, edge filtering upstream of the sensor detection element is therefore dispensed with. The light detected by the sensor detection element is only used to determine a change in wavelength, but without determining the wavelengths of the light reflected or transmitted by the sensor FBG. Since no filter is interposed between the sensor fiber and the sensor detection element, no wavelength selection takes place prior to detection via the sensor detection element in accordance with the invention. This simplifies the required measuring arrangement.

The light source has a wavelength-dependent or frequency-dependent intensity distribution (frequency pattern/frequency spectrum), i.e. the emitted light has different intensities for different wavelengths. According to the invention, a light source is used whose wavelength-dependent intensity distribution has an edge, preferably with a steepness of at least 30 nW/nm and a length of at least 6 nm, preferably of at least 8 nm. The edge can be a descending or an ascending edge. The edge steepness of the light source can be flatter if, in return, the analog amplification factor is increased, i.e. the signal amplification factor that is set in the electronic circuit that converts the current of the detection element into a voltage.

In the method according to the invention, this wavelength-dependent intensity distribution takes over the task of the edge filter known from the prior art. Due to the wavelength-dependent intensity distribution, a change in wavelength causes a change in the overall intensity of the light transmitted or reflected by the sensor FBG, so that a change in intensity measured by the sensor detection element can be used to infer a load on the FBG or the object to which the FBG is attached. For this purpose, a “constant signal” is preferably subtracted from the measured raw measurement data (intensity measured by the detection element) as part of data processing, so that the value 0 is output if no force is applied.

A mechanical force acting on the object is detected when a change in wavelength is determined with the sensor detection element.

The detection element is preferably a photodetector, e.g. a photodiode.

When evaluating the light reflected by the sensor FBG (reflection variant), the entire spectrum of the light source is preferably coupled into the sensor fiber. The light detected by the sensor detection element only covers a limited wavelength range due to the limited reflection spectrum of FBGs.

When evaluating the light transmitted by the sensor FBG (transmission variant), on the other hand, all the non-reflected light is coupled out of the sensor fiber, which generally covers a very large wavelength range, so that a relatively large constant signal would have to be subtracted from the raw data, which reduces the detection accuracy. In order to increase the detection accuracy, the light from the light source is therefore band-filtered using a filter element before the light is coupled into the sensor fiber in this method variant. For example, a bandpass filter or a broadband FBG can be used for band filtering. The bandwidth is preferably between 15 and 20 nm.

In a particularly preferred variant, the light source and the sensor FBG are matched to each other in such a way that the Bragg wavelength of the sensor FBG is in a wavelength range in which the wavelength-dependent intensity distribution of the light source has the edge, preferably in the middle range of the edge. Selecting the Bragg wavelength of the sensor FBG in the area of the edge of the wavelength-dependent intensity distribution has the effect that the wavelength shift (for example by applying force to the FBG) causes a particularly clear change in intensity.

The position of the Bragg wavelength relative to the edge is preferably selected in such a way that a maximum expected load (maximum stroke) plus temperature influences do not shift the Bragg wavelength beyond the maximum (or minimum) of the wavelength-dependent intensity distribution. The resting Bragg wavelength of the sensor FBG, i.e. the Bragg wavelength of the sensor FBG in an uninfluenced state, i.e. in a state in which the sensor FBG is not exposed to any external influences (in particular without force acting on the object and at a specified temperature), is preferably selected such that it lies in the middle range of the edge. Otherwise, the edge should be selected large enough to prevent the Bragg wavelength from shifting above the maximum (or minimum) of the intensity distribution. The edge of the wavelength-dependent intensity distribution should therefore extend over a correspondingly large wavelength range.

The resting Bragg wavelength is preferably set by pretensioning the FBG before mounting it on the object. In this way, it can be ensured that the Bragg wavelength in the unloaded state of the object lies in the desired range of the edge of the wavelength-dependent intensity distribution of the light source, so that forces acting on the FBG from both directions cause a wavelength shift within the edge.

Preferably, a C-band light source, in particular, an ASE light source, is used as the light source. A C-band light source has the advantage that light in this band is only slightly attenuated in typical optical fibers and therefore enables long ranges. An ASE-band light source has the advantage that it typically has a dominant maximum at approx. 1530 nm and therefore has the required edges.

In the method according to the invention, a light source is to be used whose wavelength-dependent intensity distribution is stable over time or can be kept stable over time. The stability of the wavelength-dependent intensity distribution can be influenced, for example, by supplying the light source with a constant voltage. The term “temporally stable wavelength-dependent intensity distribution” means that the intensities are kept stable, i.e. at a constant level, for at least a short time depending on the wavelength for the working range of the FBG (wavelength interval of the Bragg wavelengths that can occur due to the maximum intended influence on the FBG). “Stable for a short time” means that the frequency pattern does not change during the expected duration of the application of force. In the field of railroad technology, where, for example, the force exerted by a train on a rail is to be measured, the duration of the force exerted would be, for example, the time required for a train to pass completely through an axle counter sensor. In particular, the stability of the frequency pattern of the light source should be guaranteed for a duration of at least a few seconds, preferably at least a few minutes.

Slow intensity deviations, on the other hand, are permissible and can be filtered out by a long-term mean value in the processing algorithm.

Since the measuring method according to the invention is sensitive to influences on the cable infrastructure, such as light intensity changes between the sensor and the evaluation device due to fiber bending, poor connections, etc., it is advantageous to monitor light intensity changes that are not attributable to the force to be detected on the object. In a particularly preferred variant of the method according to the invention, at least one interference parameter is therefore monitored which has an influence on the wavelength-dependent intensity distribution independently of the force to be detected. The influence of the interference parameter can then be extracted from the measurement signal, which is measured by means of the sensor detection element, as part of signal processing following the detection of the measurement signal. This ensures that the determined change in the Bragg wavelength of the FBG is due to a load on the object and not to any environmental influences or external interference.

To determine interference parameters relating to changes in the cable infrastructure, it is particularly advantageous if the change in the intensity of the light transmitted by the sensor FBG is determined for monitoring the interference parameter, wherein the light transmitted by the sensor FBG is directed to a monitoring detection element (PDT), preferably via a bandpass filter. The monitoring detection element is arranged at the end of the sensor fiber opposite the light source. The bandpass filter filters in a wavelength range that lies outside the operating range of the sensor FBG. The bandpass filter therefore filters out the light whose intensity can be influenced by a wavelength shift in the Bragg wavelength of the sensor FBG, but not by the application of force to the object. For example, a bandpass filter or a broadband FBG can be used for band filtering. The bandwidth is preferably 5-15 nm. The center frequency is preferably 1550 nm. The light to be detected by the sensor detection element is not filtered.

As an alternative to determining the change in intensity of the light transmitted by the sensor FBG (transmission monitoring), a monitoring FBG can be used to monitor the interference parameter, wherein the change in intensity of the light reflected by the monitoring FBG is determined for monitoring the interference parameter (reflection monitoring). In this case, the monitoring detection element is arranged at the end of the sensor fiber facing the light source.

The monitoring FBG is preferably embedded in the same sensor fiber as the sensor FBG and has a Bragg wavelength that differs from the Bragg wavelength of the sensor FBG. In the sensor fiber, light from the sensor FBG on the one hand and light from the monitoring FBG on the other hand is reflected and returned together within the sensor fiber.

When the light is decoupled from the sensor fiber, the reflected light is divided between the sensor detection element on the one hand and a bandpass filter on the other hand, which filters out the light reflected by the sensor FBG, so that only the intensity of the light reflected by the monitoring FBG is detected on the monitoring detection element. If the intensity detected by the monitoring detection element changes, it can be assumed that there is a fault in the cable infrastructure. The sensor detection element, on the other hand, measures the intensity of the light reflected by both FBGs.

In the reflection variant for detecting the measurement signal in combination with reflection monitoring, the light reflected in the sensor fiber is preferably split into two light components, one of which is guided in an unfiltered manner to the sensor detection element and the other is guided via a bandpass filter to a monitoring detection element.

To improve availability, the measurement signal is recorded in several, in particular at least four, preferably eight measurement channels. The provision of several measuring channels increases the redundancy and thus the availability of the arrangement. The light from the light source is preferably distributed to the measurement channels by means of a splitter. Preferably, the light is distributed evenly across the measuring channels.

In a particularly preferred variant of the method according to the invention, only a single monitoring detection element is used, which detects light from all measurement channels. Alternatively, a separate monitoring detection element can also be used for each measuring channel.

In a special variant of the method according to the invention, temperature differences are determined by means of an additional optical fiber with an additional FBG (temperature monitoring FBG). In this way, the temperature influence on the sensor FBG can be determined and evaluated in an evaluation algorithm. The temperature monitoring FBG is preferably arranged in the same temperature environment as the sensor FBG, but outside the mounting area of the sensor FBG. In particular, a relative temperature measurement can be carried out using the temperature monitoring FBG.

In the method variants in which an interference parameter is determined, a mechanical force acting on the object is only detected if no wavelength change or a wavelength change that is below a predetermined limit value is detected with the monitoring detection element.

Preferably, the method according to the invention is used to determine a mechanical force acting on a rail (railroad track). In particular, the method according to the invention can be used for axle counting.

The invention also relates to a measuring device for carrying out a measuring method according to one of the preceding claims, comprising a light source which has a wavelength-dependent intensity distribution with an edge, and a fiber optic sensor unit, wherein the fiber optic sensor unit has at least one measuring channel, which comprises a sensor fiber with at least one sensor fiber Bragg grating embedded in the sensor fiber with a Bragg wavelength and a sensor detection element, wherein the sensor fiber is configured to be mounted on an object in the area of the sensor FBG. According to the invention, the measuring device is configured to determine a change in the Bragg wavelength of the sensor FBG by evaluating a change in the intensity of the detected light intensity of the light reflected by the sensor FBG and/or of the entire light transmitted by the sensor FBG over the entire wavelength range of the light reflected by the sensor FBG and/or transmitted by the sensor FBG. For this purpose, the sensor fiber is connected directly to the sensor detection element (possibly via an optical distributor) and not, as in the known measuring devices, to an OEC. The measuring device is therefore constructed in such a way that the light emerging from the sensor fiber (in the reflection variant from the side facing the light source and in the transmission variant on the side facing away from the light source) is directed unfiltered onto the sensor detection element.

Preferably, the measuring device also has an evaluation unit in which the detected intensity values are compared and evaluated.

The resting Bragg wavelength of the FBG in the mounted state is preferably in the area of the edge of the wavelength-dependent intensity distribution of the light source. Preferably, a light source with an intensity maximum at 1530 nm is used. The sensor FBG is preferably pre-tensioned in the mounted state, in particular so that the Bragg wavelength in the non-tensioned state without external influences is approx. 1520 nm, and the operating range in the tensioned state is 1522-1530 nm. The resting Bragg wavelength of the sensor FBG in the pre-tensioned state is preferably approx. 1526 nm.

In a particularly preferred embodiment of the device according to the invention, a monitoring FBG is embedded in the sensor fiber, wherein the monitoring FBG has a Bragg wavelength which differs from the Bragg wavelength of the sensor FBG.

Preferably, the monitoring FBG is arranged outside the area in which the sensor FBG is attached to the object. For example, the monitoring FBG can be arranged in a fiber optic connection box.

The invention also relates to an axle counting device with a counting point comprising two measuring devices as described above.

In an axle counting device, the evaluation device comprises evaluation cards (PCB boards) with which the signals of different measuring channels can be evaluated. The invention simplifies the structure of the measuring device so that the components for detection and signal processing of a larger number of optical measuring channels can be accommodated within a single evaluation board. Preferably, in the axle counting device according to the invention, measurement channels of at least two axle counting points are evaluated by means of a single evaluation unit.

Further advantages of the invention can be extracted from the description and the drawing. Likewise, the above-mentioned features and those described in further detail below can each be used individually or collectively in any combination in accordance with the invention. The embodiments shown and described are not to be understood as an exhaustive list, but rather have an exemplary character for the description of the invention.

### BRIEF DESCRIPTION OF THE DRAWINGS

FIG. 1 shows a structure of a measuring device according to the invention for carrying out the method according to the invention, wherein the sensor signal is measured in reflection (reflection variant).

FIG. 2 shows a wavelength spectrum of an ASE C-band light source.

FIG. 3 shows a structure of a measuring device according to the invention for carrying out the method according to the invention, wherein the sensor signal is measured in transmission (transmission variant).

FIG. 4a shows the structure of the measuring device from FIG. 1 with monitoring of the cable infrastructure in transmission (reflection variant with light monitoring in transmission) with separate monitoring of several measuring channels.

FIG. 4b shows the structure of the measuring device from FIG. 1 with monitoring of the cable infrastructure in transmission (reflection variant with light monitoring in transmission) with joint monitoring of several measuring channels and temperature monitoring.

FIG. 5 shows the structure of the measuring device from FIG. 1 with monitoring of interference parameters in reflection (reflection variant with light monitoring in reflection).

FIG. 6 schematically shows the principle of correcting slow intensity deviations.

### DETAILED DESCRIPTION OF EMBODIMENTS OF THE INVENTION

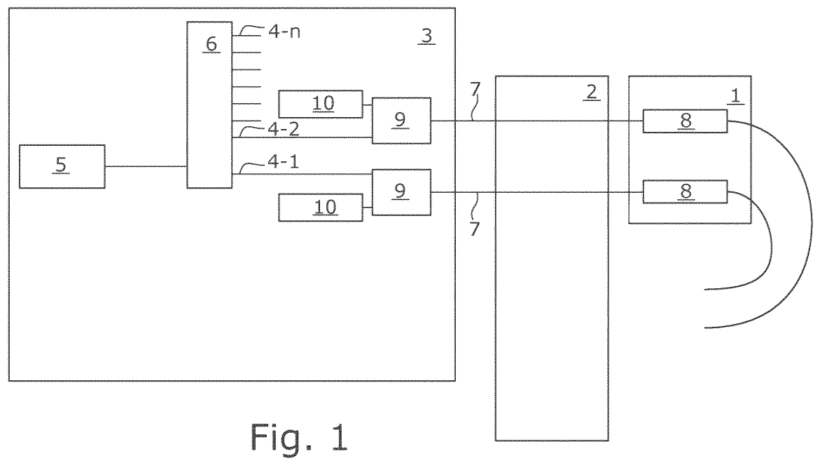

FIG. 1 shows a measuring device for carrying out a reflection variant of the method according to the invention for detecting a mechanical force acting on an object (not shown). The measuring device comprises a fiber optic sensor unit 1, which is connected to a detection unit 3 via a fiber optic connection box 2. The fiber optic sensor unit 1 is attached to the object, whereas the detection unit 3 can be located away from the object to be monitored.

In the embodiment shown in FIG. 1, a plurality of measuring channels 4-1, 4-2, . . . , 4-n are provided, each measuring channel 4-1, . . . , 4-n comprising a sensor fiber 7 and a sensor detection element 10. The analogue measured values, which are detected by the detection elements 10, are digitally converted (not shown in the figure) and evaluated by a processing element (e.g. CPU or FPGA) (not shown in the figure). The provision of several measuring channels 4-1, . . . , 4-n is not absolutely necessary, but is advantageous in terms of availability aspects. The detection unit 3 comprises a light source 5 whose light is distributed to the various measuring channels 4-1, . . . , 4-n by means of a splitter 6. The splitter 6 is preferably a 1:n splitter, which distributes the light from the light source 5 evenly to the n measuring channels 4-1, . . . , 4-n and couples it into the sensor fibers 7. A sensor fiber Bragg grating 8 (sensor FBG) is embedded in each sensor fiber 7, wherein the sensor FBGs 8 of all measuring channels 4-1, . . . , 4-n have the same Bragg wavelength in the mounted, unloaded state. In each measuring channel 4-1, . . . , 4-n, the light reflected by the sensor FBG 8 is fed back into the sensor fiber 7, guided via a coupler 9 to a sensor detection element 10 and detected there as raw data.

According to the invention, in contrast to the known methods, the entire wavelength range reflected by the sensor FBG 8 is detected by means of the sensor detection element 10, even if the Bragg wavelength of the sensor FBG 8 changes due to a load.

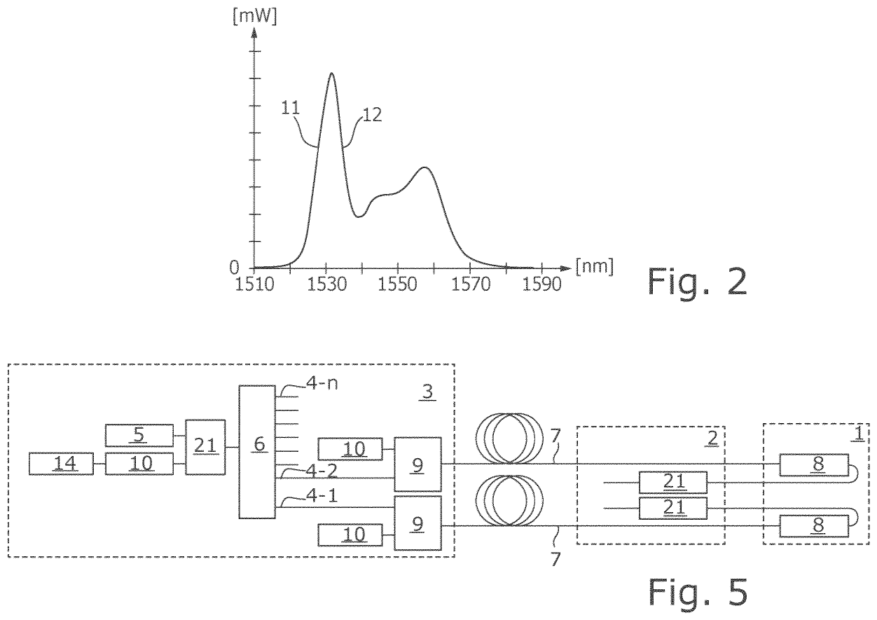

In order to be able to detect a wavelength change despite detecting the entire wavelength spectrum, the light source 5 used is a light source that has a steep edge 11, 12 in the wavelength spectrum (wavelength-dependent intensity distribution). FIG. 2 shows an example of the wavelength-dependent intensity distribution of an ASE light source with a steeply rising edge 11 and a steeply falling edge 12. The resting Bragg wavelength of the sensor FBG 8 in the mounted state is preferably selected in the middle of one of the edges 11, 12. The operating range of the sensor FBG 7 should be within one edge, here for example between 1520 nm and 1530 nm. If the Bragg wavelength now changes due to a force acting on the object, not only the wavelength changes, but also the intensity of the light reflected by the sensor FBG 8 due to the edge of the wavelength-dependent intensity distribution. In this way, it is not possible to determine the absolute Bragg wavelength, but a change in wavelength can be determined, which is sufficient for applications in the field of axle counting, for example. Since the method according to the invention is only concerned with detecting a change in the wavelength, but not the wavelength itself, the intensity of the light reflected by the sensor FBG in the unloaded state of the object (“constant signal”) is subtracted from the measured raw measurement data (intensity measured by the detection element) during data processing, so that the value 0 is output as the output signal without the application of force. The constant signal to be subtracted is preferably the mean value of the measured intensity over a specified floating period, in particular over the last few seconds, preferably in the order of magnitude of the last 10 seconds.

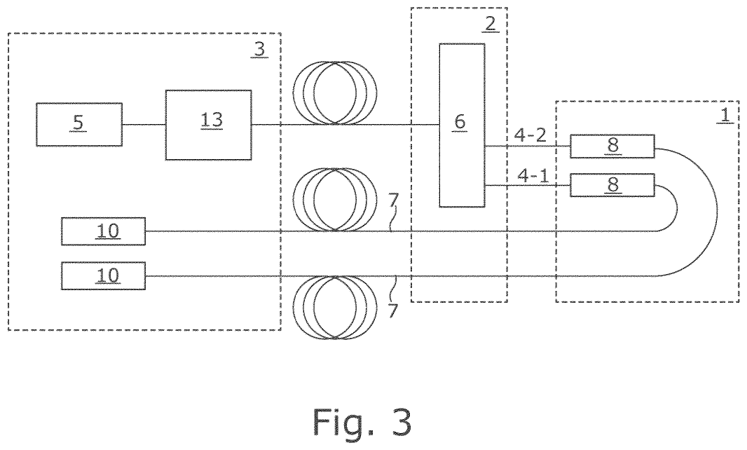

FIG. 3 shows a measuring device for an alternative method variant as an example for two measuring channels 4-1, 4-2, in which measurement is carried out in transmission (transmission variant). In contrast to the measuring arrangement used for the reflection variant (FIG. 1), in the transmission variant, the sensor detection element 10 is located at the end of the sensor fiber 7 opposite the light source 5. In this case, it is not the light reflected by the sensor FBG 8 that is detected, but the light transmitted by the sensor FBG 8. However, this means that the constant signal, which is subtracted from the raw measurement data, is relatively large compared to the change in intensity caused by the application of force. In this variant, it is therefore advantageous if the wavelength range of the light to be coupled in is limited by means of a bandpass filter 13 before the light from the light source 5 is coupled into the sensor fiber 7. The bandpass filter should cover the operating range of the sensor FBG 8 for this purpose. The bandwidth of the bandpass filter 13 is preferably 15 nm. The passband of the bandpass filter 13 is preferably 1520-1535 nm.

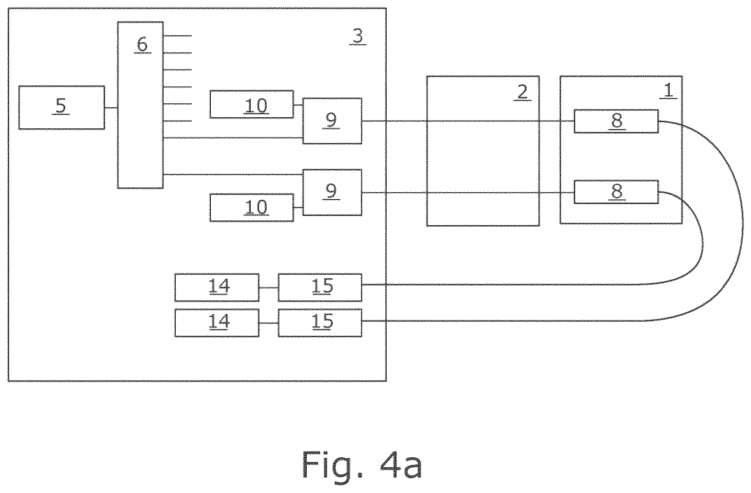

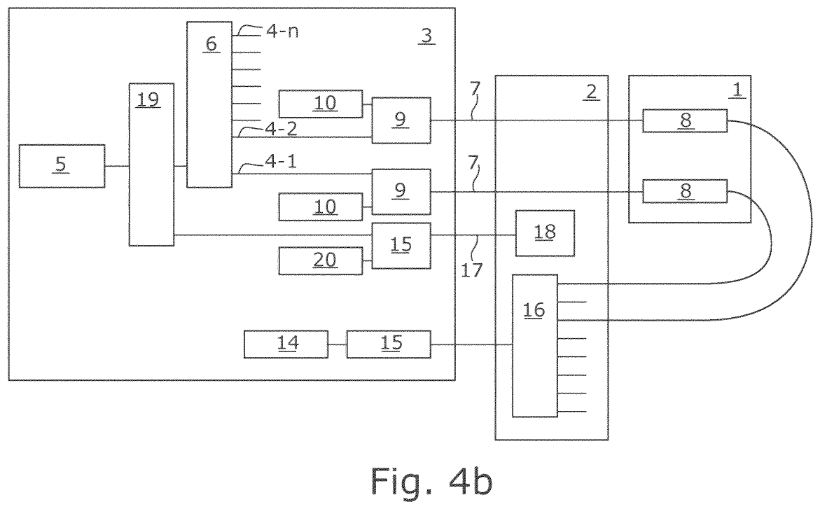

FIG. 4a, FIG. 4b and FIG. 5 show embodiments of the measuring device according to the invention for carrying out the reflection variant of the method according to the invention, wherein, in addition to the actual measurement of the light reflected by the sensor FBG 8 to determine the wavelength change, interference parameters are monitored. This is particularly advantageous, since the Bragg wavelength of the sensor FBG 8 can be influenced not only by the application of force to the object to which the sensor FBG 8 is attached, but also by interference factors, such as temperature changes or changes in the cable infrastructure (fiber bending, faulty connections, etc.), since this can cause a change in the reflected light intensity.

An additional detection element (monitoring detection element 14) is provided in the detection unit 3 in order to determine whether a change in intensity is caused by an influence on the Bragg wavelength of the sensor FBG 8 or by influences on the cable infrastructure. The monitoring detection element 14 is used to detect light from the sensor fibers 7 of the measuring channels 4-1, 4-2, . . . , 4-n, which has a wavelength outside the operating range of the sensor FBG 8. A bandpass filter 15 can optionally be connected upstream of the monitoring detection element 14, which allows a wavelength range (here: for example 1550 nm) outside the operating range of the sensor FBGs 8 to pass. This ensures that the light intensity detected by the monitoring detection element 14 is not influenced by a load acting on the object, but is significant in terms of the cable infrastructure. However, since the monitoring signal measured in transmission is much larger than the measurement signal measured in reflection, the influence of the shift in the Bragg wavelength due to a load acting on the object on the monitoring signal is small. It is therefore also possible to dispense with the bandpass filter 15. If the light intensity changes due to a change in the cable infrastructure, this can be detected by means of an intensity change detected by the monitoring detection element 14.

In the embodiments shown in FIG. 4a and FIG. 4b, the monitoring detection element 14 is located at the end of the sensor fibers 7 opposite the light source 5 and is used to detect the light transmitted by the sensor FBGs 8 of the sensor fibers 7 of the various measurement channels 4-1, . . . , 4-n. Monitoring can be carried out separately for each measuring channel 4-1, . . . , 4-n. For this purpose, a separate monitoring detection element 14 is provided for each measuring channel 4-1, . . . , 4-n in the embodiment shown in FIG. 4a. Alternatively, the transmitted light from all measuring channels 4-1, . . . , 4-n can be combined by means of a further splitter 16 and directed to a common monitoring detection element 14, as shown in FIG. 4b.

In addition to monitoring the cable infrastructure, temperature monitoring is also provided in the embodiment shown in FIG. 4b. For this purpose, part of the light from the light source 5 is coupled into an additional optical fiber 17 with an additional FBG (temperature monitoring FBG 18). The splitting of the light from the light source 5 into the measuring channels 4-1, . . . , 4-n on the one hand and into the additional fiber 17 on the other hand can be carried out with an additional splitter 19, which is arranged between the light source 5 and the splitter 6, which serves to split the light into the various measuring channels 4-1, . . . 4-n. The additional splitter is preferably a 90:10 or 80:20 splitter, so that only a small part of the light is coupled into the additional fiber 17 and most of the light is directed to the splitter 6. The light reflected by the temperature monitoring FBG 18 is detected by means of an additional monitoring detection element 20. In the example shown, the temperature monitoring FBG 18 is not part of the fiber optic unit 1, which is attached to the object to be monitored, but is housed in the fiber optic connection box. However, it should be located close to the object to be monitored so that the temperature monitoring FBG 18 is exposed to the same temperature fluctuations as the sensor FBG 8.

As an alternative to the embodiments shown in FIG. 4a and FIG. 4b, in which the monitoring of the cable infrastructure is determined by means of the light transmitted by the sensor FBG 8, an embodiment is shown in FIG. 5 in which the cable infrastructure is monitored by means of a further FBG embedded in the sensor fiber 7 (monitoring FBG 21). The monitoring detection element 14 is located on the end of the sensor fibers 7 facing the light source 5 and is used to detect the light transmitted by the sensor FBG 8 of the sensor fibers 7 of the various measurement channels 4-1, . . . , 4-n.

The monitoring FBG 21 has a Bragg wavelength that lies outside the operating range of the sensor FBG 8. This means that within the sensor fiber 7, light reflected by the sensor FBG 8 is returned on the one hand and light reflected by the monitoring FBG 21 is returned on the other hand. The reflected light is distributed via the coupler 9 to the sensor detection element 10 on the one hand and to the monitoring detection element 14 on the other hand. In order to guide the light emitted by the light source 5 into the sensor fiber 8 and one of the light portions of the light reflected from the sensor fiber 8 to the bandpass filter 15, a further coupler or circulator 21 is provided, which connects the light source 5, the bandpass filter 15 and the sensor fiber 7 or the upstream splitter 6.

If a change in intensity is registered by the monitoring detection elements 14, 20 shown in FIG. 4a, FIG. 4b or FIG. 5, this is offset against the measurement signal of the sensor detection element 10 in order to rule out false axis detection. In this way, short-term changes in the wavelength-dependent intensity distribution and associated intensity fluctuations in the sensor fiber 7 can be prevented from influencing the actual measurement result, so that it can be reliably determined whether a force has been applied to the object to be monitored

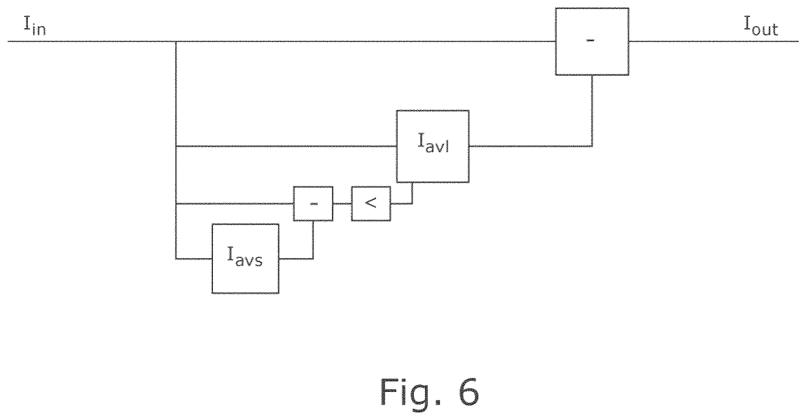

FIG. 6 shows schematically how long-term changes in the wavelength-dependent intensity distribution can be corrected: In general, a constant value is subtracted from the raw data detected by the sensor detection element 10 (input signal Iin) so that the value 0 is output as the output signal Iout if no force has been applied to the object.

Preferably, the constant value is a floating long mean value Iavl of the light intensity detected by the sensor detection element 10.

Long mean values Iavl is constantly updated as long as the signal is not influenced by external circumstances, in particular the effect of force on the object or a change in temperature. To ensure that the constant value does not contain any signal influence, a short mean value Iavs of the light intensity detected by the sensor detection element 10 is preferably also calculated, wherein a shorter time period is used to calculate the short mean value Iavs than to calculate the long mean value Iavl. For example, the short mean value Iavs can be calculated over a period of approx. 2.5 seconds and the long mean value Iavl can be calculated over a period of approx. 10 seconds.

The short mean value Iavs is subtracted from the input signal Iin. If the amount of the result is less than a defined limit value Ilim, the currently calculated long mean value Iavl is used as a constant value. If the result exceeds the defined limit value Ilim, the currently calculated long mean value Iavs is discarded. Preferably in this case, a previously calculated long mean value is used as a constant value for which the difference between the associated short mean value Iavs and input signal Iin has not exceeded the limit value.

This method ensures that no measurement events, i.e. measurement signals during a load on the object, are included in the long mean value calculation.

By subtracting the constant value from the input signal Iin, an output signal Iout is generated which has the value 0 in the unaffected state. The algorithms for identifying the force detection on the object (e.g. axle detection in an axle counting system) are then applied to this output signal Iout.

### LIST OF REFERENCE SIGNS

1 fiber optic sensor unit
2 fiber optic connection box
3 detection unit (counting board)
4-1 . . . 4-n measuring channels
5 light source
6 splitter for splitting the light from the light source to be coupled into the measuring channels
7 sensor fiber
8 sensor fiber Bragg grating
9 coupler for coupling the light from the light source into the sensor fiber and for decoupling the reflected light from the sensor fiber
10 sensor detection element
11 rising edge of the wavelength-dependent intensity distribution
12 falling edge of the wavelength-dependent intensity distribution
13 bandpass filter with filter bandwidth in the operating range of the sensor FBG
14 monitoring detection element for monitoring the cable infrastructure
15 bandpass filter with filter bandwidth outside the operating range of the sensor FBG
16 splitter for combining the light transmitted from the sensor fibers of the measuring channels
17 additional optical fiber for temperature monitoring
18 temperature monitoring FBG of the additional fiber
19 additional splitter for splitting the light between the fiber for temperature monitoring and the sensor fibers
20 additional monitoring detection element for monitoring the temperature
21 coupler/circulator
Iavs short mean value
Iavl long mean value, constant signal
Iin input signal
Iout output signal
Ilim limit value for deviation from short mean value to input signal

### LITERATURE LIST

DE 10 2017 119 810 B4
DE 10 2014 100 653 B4
EP 3 069 952 A1
DE 10 2012 104 874 B4

What is claimed is:

1. A measuring method for detecting a mechanical force acting on an object by a fiber optic sensor unit, wherein at least one measuring channel is present which comprises a sensor fiber with at least one sensor fiber Bragg grating with a Bragg wavelength, the fiber Bragg grating being embedded in the sensor fiber, and a sensor detection element, wherein the sensor fiber is attached to the object in the area of the sensor FBG, wherein the method comprises:
coupling light from a light source into the sensor fiber:
detecting the light reflected and/or transmitted by the sensor FBG by means of the sensor detection element;
wherein the light source has a wavelength-dependent intensity distribution with an edge;
wherein the light reflected and/or transmitted by the sensor FBG is detected by means of the sensor detection element over the entire wavelength range of the light reflected and/or transmitted by the sensor FBG; and
wherein a wavelength change in the Bragg wavelength of the sensor FBG is determined by evaluating a measurement signal which comprises an intensity change in the light intensity detected by the sensor detection element.

2. The measuring method according to claim 1, wherein the light source and the sensor FBG are tuned to each other wherein the Bragg wavelength of the sensor FBG lies in a wavelength range in which the frequency pattern of the light source has the edge, in the middle range of the edge.

3. The measuring method according to claim 1, wherein a C-band light source, being an ASE light source, is used as the light source.

4. The measuring method according to claim 1, wherein at least one interference parameter is monitored which has an influence on the wavelength-dependent intensity distribution independently of a force acting on the object.

5. The measuring method according to claim 4, wherein the change in the intensity of the light transmitted by the sensor FBG is determined for monitoring the interference parameter, the light transmitted by the sensor FBG being directed, via a bandpass filter, to a monitoring detection element.

6. The measuring method according to claim 4, wherein a monitoring FBG is used to monitor the interference parameter, and in that the change in the intensity of the light reflected by the monitoring FBG is determined for monitoring the interference parameter.

7. The measuring method according to claim 6, wherein the monitoring FBG is embedded in the same measuring fiber as the sensor FBG, wherein the monitoring FBG has a Bragg wavelength which differs from the Bragg wavelength of the sensor FBG.

8. The measuring method according to claim 6, wherein the light reflected in the measuring fiber is divided into two light components, one of which is passed unfiltered to the sensor detection element and the other is passed via a bandpass filter to a monitoring detection element.

9. The measuring method according to claim 5, wherein the fiber optic sensor unit has at least four measuring channels, and wherein only a single monitoring detection element is used, which detects light from all measurement channels.

10. The measuring method according to claim 5, wherein the fiber optic sensor unit has at least four measuring channels, and wherein several monitoring detection elements are used, and wherein one separate monitoring detection element is used for each measuring channel.

11. The measuring method according to claim 1, wherein a force acting on the object is determined if a wavelength change is determined with the sensor detection element, wherein only if no wavelength change or a wavelength change which is below a predetermined limit value is determined with the monitoring detection element.

12. The measuring method according to claim 1 for use in determining a mechanical force acting on a rail for use in a counting point of an axle counting device.

13. The measuring device for carrying out the measuring method according to claim 1, comprising a light source which has a wavelength-dependent intensity distribution with an edge, and a fiber optic sensor unit, the fiber optic sensor unit having at least one measuring channel which comprises a sensor fiber with at least one sensor fiber Bragg grating (S-FBG) embedded in the sensor fiber with a Bragg wavelength and a sensor detection element, the sensor fiber being configured to be mounted on an object in the area of the sensor FBG, wherein the fiber optic sensor unit is configured to determine a change in the Bragg wavelength of the sensor FBG by evaluating a change in the intensity of the detected light intensity of the light reflected by the sensor FBG and/or of the entire light transmitted by the sensor FBG over the entire wavelength range of the light reflected by the sensor FBG and/or transmitted by the sensor FBG.

14. The measuring device according to claim 13, wherein the Bragg wavelength of the FBG in the mounted state lies in the area of the edge of the wavelength-dependent intensity distribution of the light source.

15. The measuring device according to claim 13, wherein a monitoring FBG is embedded in the sensor fiber, wherein the monitoring FBG has a Bragg wavelength which differs from the Bragg wavelength of the sensor FBG, and wherein the monitoring FBG can be positioned outside the area in which the sensor FBG is attached to the object.

16. An axle counting device with a counting point comprising two measuring devices according to claim 13.
